(19) United States
(12) Patent Application Publication
(10) Pub. No.: US 2024/0334905 A1
(43) Pub. Date: Oct. 10, 2024

(54) Manual and Automatic Dual-purpose Bark Stopper

(71) Applicant: Bo LI, Ezhou (CN)

(72) Inventor: Bo LI, Ezhou (CN)

(21) Appl. No.: 18/130,917

(22) Filed: Apr. 5, 2023

(51) Int. Cl. A01K 15/02

(52) U.S. Cl. CPC A01K 15/022

(57) ABSTRACT

Disclosed in the disclosure is a manual and automatic dual-purpose bark stopper, including a remote control and a receiver, wherein the remote control is provided with a function switching key; and the main control board is provided with a dog training control unit and a bark stopping control unit, respectively, and the main control board receives an instruction from the function switching key to switch between the dog training control unit and the bark stopping control unit to control the vibration motor, or the ultrasonic generator or the electric shock electrode, thereby switching the receiver to be in a working mode of dog training or of bark stopping.

### TECHNICAL FIELD

The disclosure relates to electronic products for pets, in particular to a manual and automatic dual-purpose bark stopper.

### BACKGROUND

Pet dogs tend to bark when stimulated by external sounds, thus affecting others. In order to prevent the pet dogs from barking too often or for too long, people have also designed bark stoppers. People make the pet dogs stop barking by stimulating them when they bark loudly.

However, existing bark stoppers are simplex in both structure and function, and inevitably have many defects when in use. In general, the pet dogs cannot always accurately correlate the warning or disciplinary measures imposed on them by the bark stoppers with their own barking behaviors that have just occurred, especially if they have just started using the bark stoppers. From the dogs' standpoint, being beaten or kicked for unknown reasons can only create the impression of “being abused”, and dogs growing up in such an environment are extremely insecure, sometimes attacking weaker children or the elderly, or even biting people in dangerous incidents.

Moreover, the existing bark stoppers are prone to being disturbed by other louder sounds from the outside world, which can lead to misjudgment and wrong warning or discipline for the pet dogs.

### SUMMARY

The disclosure aims to provide a manual and automatic dual-purpose bark stopper.

According to one aspect of the disclosure, provided is a manual and automatic dual-purpose bark stopper, including a receiver tied to the neck of a pet dog through a strap, and a remote control connected with the receiver through a signal.

The receiver includes a main control board and a pickup. The main control board is connected with at least one of a vibration motor, or an ultrasonic generator or an electric shock electrode. The pickup is connected with the main control board. The remote control is provided with a function control key which is configured to respectively control the vibration motor, or the ultrasonic generator or the electric shock electrode connected with the main control board. The function control key corresponds to the vibration motor, or the ultrasonic generator or the electric shock electrode connected with the main control board, respectively.

The bark stopper has two working modes of an automatic mode and a manual mode.

In the automatic mode, the receiver can work automatically upon startup, without receiving a signal from the remote control. After receiving the barking sound of the pet dog, the pickup converts the barking sound into an electric signal and sends the electric signal to the main control board. After receiving the electric signal, the main control board issues a bark stopping instruction to make at least one of the vibration motor or the ultrasonic generator or the electric shock electrode work, thus warning or disciplining the barking pet dog.

In the manual mode, the receiver receives signal control of the remote control, and by pressing the function control key to make the corresponding vibration motor, or ultrasonic generator or electric shock electrode work, the pet dog is warned or disciplined. The function control key controls the receiver in an instant clicking mode.

By adopting the bark stopper of the above technical solution, when the remote control is not used, it can achieve the function of automatically warning or disciplining the barking pet dog through the pickup arranged on the bark stopper, and when the remote control is used, it can warn or discipline the pet dog once by manual operation of the function control key. The manual operation of the remote control is relatively intuitive and easy for the pet dog to understand. It can make the pet dog quickly and accurately correlate the warning or disciplinary measures imposed on it by the bark stopper with its own barking behavior that has just occurred, so as to make the pet dog feel afraid and turn back, thus reducing barking. Also, through the remote control, the owner can repeat the warning or discipline to the pet dog multiple times to enhance the pet dog's memory, so as to achieve the degree of conditioned reflex as soon as possible.

In some implementations, the main control board is connected with the vibration motor, or the ultrasonic generator or the electric shock electrode that is connected with the main control board, respectively, and after receiving the electric signal, the main control board analyzes and processes the electric signal as necessary to inversely deduce frequency and intensity of the sound received by the pickup, which are used as the judgment basis for issuing a bark stopping instruction. The bark stopper thus can conduct scientific analysis according to different situations to warn or discipline the pet dog to different degrees.

Further, the main control board divides the sound intensity of barking of the pet dog into three orders of magnitude from weak to strong according to the electric signal. At the first order of magnitude, the sound intensity of barking of the pet dog is low, and the main control board issues a bark stopping instruction to start the vibration motor to make the pet dog feels vibration warning. At the second order of magnitude, the sound intensity of barking of the pet dog is moderate, and the main control board issues a bark stopping instruction to start the ultrasonic generator, which emits ultrasonic waves sufficient to cause discomfort to the pet dog. At the third order of magnitude, the sound intensity of barking of the pet dog is high, and the main control board issues a bark stopping instruction to start the electric shock electrode, which emits a high-voltage microcurrent to conduct electric shock discipline on the neck of the pet dog. The pet dog thus can be gradually warned or disciplined according to the magnitude of the barking sound, thereby achieving a better effect of education.

Specifically, the three orders of magnitude are respectively that the first order of magnitude is 20 to 40 db, the second order of magnitude is 41 to 60 db, and the third order of magnitude is greater than 60 db.

In some implementations, the main control board can also divide the sound frequency of barking of the pet dog into three categories according to the electric signal, and the three categories correspond to different intensities of the high-voltage microcurrent emitted from the electric shock electrode. The sound frequency of barking is associated with the size of the pet dog. Through the sound frequency of barking, different sizes of pet dogs were given different intensities of electric shock stimulation, which can avoid the situation that too low-intensity electric shock stimulation has no effect on large dogs or too high-intensity electric shock stimulation causes great harm to small dogs.

In some implementations, the three categories are respectively that the first category is 1100 Hz to 1800 Hz, at which an intensity of the high-voltage microcurrent emitted from the electric shock electrode is 60%; the second category is 651 Hz to 1099 Hz, at which an intensity of the high-voltage microcurrent emitted from the electric shock electrode is 80%; and the third category is 450 Hz to 650 Hz, at which an intensity of the high-voltage microcurrent emitted from the electric shock electrode is 100%. According to the frequency of barking, the first category, the second category and the third category correspond to small dogs, medium dogs and large dogs. It is scientific and reasonable to set the intensities of the high-voltage microcurrents for electric shock stimulation in the small and medium dogs to 60% and 80% of that in the large dogs, respectively.

In other implementations, the three categories are respectively that the first category is 1100 Hz to 1800 Hz, at which a time of duration of the high-voltage microcurrent emitted from the electric shock electrode is 60%; the second category is 651 Hz to 1099 Hz, at which a time of duration of the high-voltage microcurrent emitted from the electric shock electrode is 80%; and the third category is 450 Hz to 650 Hz, at which a time of duration of the high-voltage microcurrent emitted from the electric shock electrode is 100%. It is scientific and reasonable to set the times of duration of the high-voltage microcurrents for electric shock stimulation in the small and medium dogs to 60% and 80% of that in the large dogs, respectively.

Further, the pickup is also connected with a double-trigger switch module in series, and when and only when the pickup detects two consecutive sound signals within 5-10 seconds, is the double-trigger switch module turned on, and the control board issues the bark stopping instruction.

Specifically, the double-trigger switch module includes two NAND gates and a timer, and both NAND gates are triggered on by the pickup. When the pickup receives a sound signal for the first time, the first NAND gate is turned on and the timer starts to work. When and only when the pickup detects a sound again within 5-10 seconds, is the second NAND gate turned on, and the main control board issues a bark stopping instruction.

Specifically, the double-trigger switch module includes a time delay switch and an ordinary switch which are sequentially connected in series. The ordinary switch is triggered on by the pickup through the time delay switch. When the pickup receives a sound signal for the first time, the time delay switch is turned on for 5-10 seconds and then turned off. When the pickup detects a sound again within 5-10 seconds, the ordinary switch is turned on, and the main control board issues a bark stopping instruction.

### BRIEF DESCRIPTION OF FIGURES

FIG. 1 is a schematic structural diagram of a manual and automatic dual-purpose bark stopper according to an implementation of the disclosure.

FIG. 2 is an assembly diagram of a receiver as shown in FIG. 1.

FIG. 3 is a schematic circuit diagram of the receiver as shown in FIG. 1.

### DETAILED DESCRIPTION

The disclosure will be further described in detail below in conjunction with accompanying drawings.

### Embodiment 1

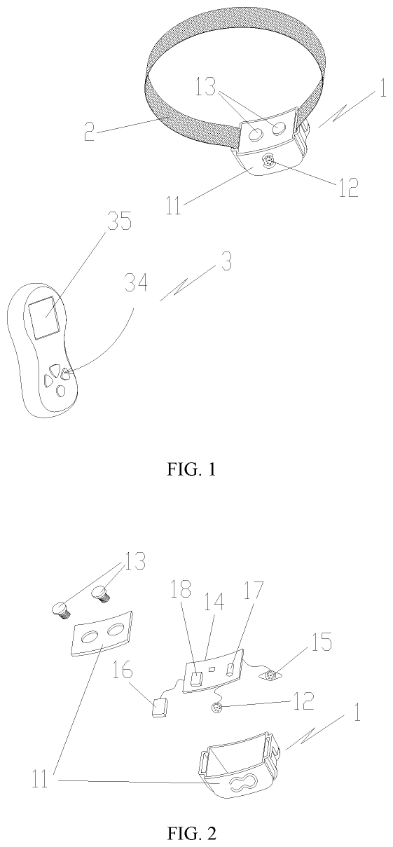

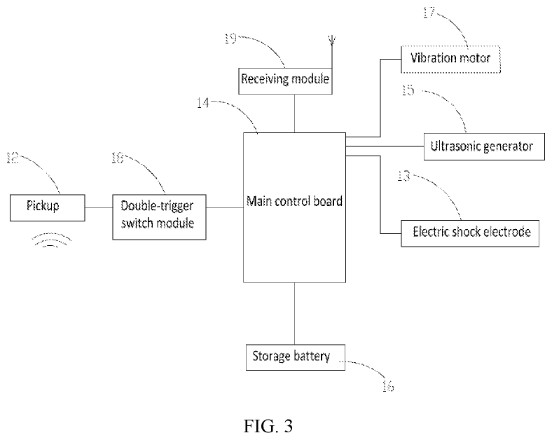

FIGS. 1 to 3 schematically shows a manual and automatic dual-purpose bark stopper according to an implementation of the disclosure. As shown in drawings, the device includes a remote control 3 and a receiver 1.

The receiver 1 is fixed to the neck of a pet dog through a strap 2.

The receiver 1 includes a housing 11 and a main control board 14 arranged inside the housing 11. The housing 11 is also internally provided with a pickup 12.

The main control board 14 is also connected with a storage battery 16. The storage battery 16 is a dry battery or a rechargeable battery, and is configured to supply power to the main control board 14.

The housing 11 is also externally provided with an electric shock electrode 13, and the electric shock electrode 13 is close to the skin of the animal. The electric shock electrode 13 is connected with the main control board 14 and receives an instruction from the main control board 14.

The housing 11 is also internally provided with a vibration motor 17 and an ultrasonic generator 15. The vibration motor 17 and the ultrasonic generator 15 are connected with the main control board 14, respectively, and receive the instruction from the main control board 14.

The main control board 14 is also connected with a receiving module 19, which is configured to a signal from the remote control 3.

The pickup 12 is connected with the main control board 14.

The remote control 3 is also provided with a function control key 34 and a display screen 35.

The function control key 34 which is configured to control the vibration motor 17, the ultrasonic generator 15 and the electric shock electrode 13 connected with the main control board 14 corresponds to the vibration motor 17, or the ultrasonic generator 15 or the electric shock electrode 13, respectively.

The bark stopper has two working modes of an automatic mode and a manual mode.

In the automatic mode, the receiver 1 can work automatically upon startup, without receiving a signal from the remote control 3. After receiving the barking sound of the pet dog, the pickup 12 converts the barking sound into an electric signal and sends the electric signal to the main control board 14. After receiving the electric signal, the main control board 14 issues a bark stopping instruction to make at least one of the vibration motor 17 or the ultrasonic generator 15 or the electric shock electrode 13 work, thus warning or disciplining the barking pet dog.

In the manual mode, the receiver 1 receives signal control of the remote control 3. The function control key 34 controls the receiver 1 in an instant clicking mode. By pressing the function control key 34 to make the corresponding vibration motor 17, or ultrasonic generator 15 or electric shock electrode 13 work, the pet dog is warned or disciplined.

In the embodiment, the pickup 12 is also connected with a double-trigger switch module 18 in series.

The pickup 12 triggers the double-trigger switch module 18 when detecting an external sound signal.

When and only when the pickup 12 detects two consecutive sound signals within a predetermined time, may the double-trigger switch module 18 be turned on. The main control board 14 issues a bark stopping instruction, and the receiver 1 warns or disciplines the animal by vibration or ultrasonic waves or electric shock.

The predetermined time is typically 5-10 seconds.

The double-trigger switch module 18 includes two NAND gates and a timer, and both NAND gates are triggered on by the pickup 12. When the pickup 12 receives a sound signal for the first time, the first NAND gate is turned on and the timer starts to work. When and only when the pickup 12 detects a sound again within 5-10 seconds, is the second NAND gate turned on, and the main control board 14 issues a bark stopping instruction.

The NAND gates and the timer herein as common pins of a single-chip microcomputer can be led out for use through corresponding line connection.

When the double-trigger switch module 18 is turned on, the main control board 14 controls the vibration motor 17 to produce vibration, or the ultrasonic generator 17 to emit ultrasonic waves, or the electrode 13 to conduct high-voltage microcurrent electric shock, thus warning the barking pet dog.

According to the manual and automatic dual-purpose bark stopper provided by the disclosure, when the remote control is not used, it can achieve the function of automatically warning or disciplining the barking pet dog through the pickup arranged on the bark stopper, and when the remote control is used, it can warn or discipline the pet dog once by manual operation of the function control key. The manual operation of the remote control is relatively intuitive and easy for the pet dog to understand. It can make the pet dog quickly and accurately correlate the warning or disciplinary measures imposed on it by the bark stopper with its own barking behavior that has just occurred, so as to make the pet dog feel afraid and turn back, thus reducing barking. Also, through the remote control, the owner can repeat the warning or discipline to the pet dog multiple times to enhance the pet dog's memory, so as to achieve the degree of conditioned reflex as soon as possible. In addition, the double-trigger switch module is also used in the receiver, when and only when the pickup detects two consecutive sound signals within 5-10 seconds, can the control board issue the bark stopping instruction. Thus, the probability of misjudgment of the bark stopper can be greatly reduced, which can better play the role of dog training, helping the pet dog to develop good habits.

### Embodiment 2

Different from Embodiment 1, a double-trigger switch module 18 includes a time delay switch and an ordinary switch which are sequentially connected in series. The ordinary switch is triggered on by the pickup 12 through the time delay switch. When the pickup 12 receives a sound signal for the first time, the time delay switch is turned on for 5-10 seconds and then turned off. When the pickup 12 detects a sound again within 5-10 seconds, the ordinary switch is turned on, and the main control board 14 issues a bark stopping instruction.

When the double-trigger switch module 18 is turned on, the main control board 14 firstly controls the vibration motor 17 to produce vibration, or the ultrasonic generator 15 to emit ultrasonic waves to warn the animal.

After the double-trigger switch module 18 is turned on to warn the animal, if the pickup 12 detects the sound again, the main control board 14 controls the electrode 13 to generate electric shock to discipline the animal.

### Embodiment 3

Different from Embodiment 1, after receiving an electric signal, a main control board 14 analyzes and processes it as necessary to inversely deduce frequency and intensity of the sound received by the pickup 12, which are used as the judgment basis for issuing a bark stopping instruction. The bark stopper thus can conduct scientific analysis according to different situations to warn or discipline the pet dog to different degrees.

The main control board 14 divides the sound intensity of barking of the pet dog into three orders of magnitude from weak to strong according to the electric signal. At the first order of magnitude, the sound intensity of barking of the pet dog is low, and the main control board 14 issues a bark stopping instruction to start a vibration motor 17 to make the pet dog feels vibration warning. At the second order of magnitude, the sound intensity of barking of the pet dog is moderate, and the main control board 14 issues a bark stopping instruction to start an ultrasonic generator 15, which emits ultrasonic waves sufficient to cause discomfort to the pet dog. At the third order of magnitude, the sound intensity of barking of the pet dog is high, and the main control board 14 issues a bark stopping instruction to start an electric shock electrode 13, which emits a high-voltage microcurrent to conduct electric shock discipline on the neck of the pet dog. The pet dog thus can be gradually warned or disciplined according to the magnitude of the barking sound, thereby achieving a better effect of education.

The three orders of magnitude are respectively that the first order of magnitude is 20 to 40 db, the second order of magnitude is 41 to 60 db, and the third order of magnitude is greater than 60 db.

The main control board 14 can also divide the sound frequency of barking of the pet dog into three categories according to the electric signal, and the three categories correspond to different intensities of the high-voltage microcurrent emitted from the electric shock electrode 13. The sound frequency of barking is associated with the size of the pet dog. Through the sound frequency of barking, different sizes of pet dogs were given different intensities of electric shock stimulation, which can avoid the situation that too low-intensity electric shock stimulation has no effect on large dogs or too high-intensity electric shock stimulation causes great harm to small dogs.

The three categories are respectively that the first category is 1100 Hz to 1800 Hz, at which an intensity of the high-voltage microcurrent emitted from the electric shock electrode 13 is 60%; the second category is 651 Hz to 1099 Hz, at which an intensity of the high-voltage microcurrent emitted from the electric shock electrode 13 is 80%; and the third category is 450 Hz to 650 Hz, at which an intensity of the high-voltage microcurrent emitted from the electric shock electrode 13 is 100%. According to the frequency of barking, the first category, the second category and the third category correspond to small dogs, medium dogs and large dogs. It is scientific and reasonable to set the intensities of the high-voltage microcurrents for electric shock stimulation in the small and medium dogs to 60% and 80% of that in the large dogs, respectively.

In other embodiments, the three categories are respectively that the first category is 1100 Hz to 1800 Hz, at which a time of duration of the high-voltage microcurrent emitted from the electric shock electrode is 60%; the second category is 651 Hz to 1099 Hz, at which a time of duration of the high-voltage microcurrent emitted from the electric shock electrode is 80%; and the third category is 450 Hz to 650 Hz, at which a time of duration of the high-voltage microcurrent emitted from the electric shock electrode is 100%. It is scientific and reasonable to set the times of duration of the high-voltage microcurrents for electric shock stimulation in the small and medium dogs to 60% and 80% of that in the large dogs, respectively.

The above is only some implementations of the disclosure. For those of ordinary skill in the art, various modifications and improvements can be made without departing from the conception of the disclosure, all of which should fall within the scope of protection of the disclosure.

What is claimed is:

1. A manual and automatic dual-purpose bark stopper, comprising a receiver provided on a strap and the strap is configured to be tied to a neck of a pet dog, and a remote control connected with the receiver through a signal, wherein
the receiver comprises a main control board and a pickup, the main control board is connected with at least one of a vibration motor, or an ultrasonic generator or an electric shock electrode, the pickup is connected with the main control board, and the remote control is provided with a function control key which is configured to respectively control the vibration motor, or the ultrasonic generator or the electric shock electrode connected with the main control board;
when working in an automatic mode, after receiving a barking sound of the pet dog, the pickup converts the barking sound into an electric signal and sends the electric signal to the main control board, after receiving the electric signal, the main control board issues a bark stopping instruction to make at least one of the vibration motor or the ultrasonic generator or the electric shock electrode work, thus warning or disciplining the barking pet dog; and
when working in a manual mode, by pressing the function control key to make at least one of the vibration motor, or ultrasonic generator or electric shock electrode work, the pet dog is warned or disciplined.

2. The manual and automatic dual-purpose bark stopper according to claim 1, wherein the main control board is connected with the vibration motor, or the ultrasonic generator or the electric shock electrode that is connected with the main control board, respectively, and after receiving the electric signal, the main control board analyzes and processes the electric signal as necessary to inversely deduce frequency and intensity of the sound received by the pickup, which are used as judgment basis for issuing the bark stopping instruction.

3. The manual and automatic dual-purpose bark stopper according to claim 2, wherein the main control board divides a sound intensity of barking of the pet dog into three orders of magnitude from weak to strong according to the electric signal, wherein at a first order of magnitude, the sound intensity of barking of the pet dog is low, and the main control board issues a bark stopping instruction to start the vibration motor to make the pet dog feels vibration warning; at a second order of magnitude, the sound intensity of barking of the pet dog is moderate, and the main control board issues a bark stopping instruction to start the ultrasonic generator, which emits ultrasonic waves sufficient to cause discomfort to the pet dog; and at a third order of magnitude, the sound intensity of barking of the pet dog is high, and the main control board issues a bark stopping instruction to start the electric shock electrode, which emits a high-voltage microcurrent to conduct electric shock discipline on the neck of the pet dog.

4. The manual and automatic dual-purpose bark stopper according to claim 3, wherein the three orders of magnitude are respectively that the first order of magnitude is 20 to 40 db, the second order of magnitude is 41 to 60 db, and the third order of magnitude is greater than 60 db.

5. The manual and automatic dual-purpose bark stopper according to claim 2, wherein the main control board divides sound frequency of barking of the pet dog into three categories according to the electric signal, and the three categories correspond to different intensities of a high-voltage microcurrent emitted from the electric shock electrode.

6. The manual and automatic dual-purpose bark stopper according to claim 5, wherein the three categories are respectively that the first category is 1100 Hz to 1800 Hz, at which an intensity of the high-voltage microcurrent emitted from the electric shock electrode is 100%; the second category is 651 Hz to 1099 Hz, at which an intensity of the high-voltage microcurrent emitted from the electric shock electrode is 80%; and the third category is 450 Hz to 650 Hz, at which an intensity of the high-voltage microcurrent emitted from the electric shock electrode is 60%.

7. The manual and automatic dual-purpose bark stopper according to claim 5, wherein the three categories are respectively that the first category is 1100 Hz to 1800 Hz, at which a time of duration of the high-voltage microcurrent emitted from the electric shock electrode is 100%; the second category is 651 Hz to 1099 Hz, at which a time of duration of the high-voltage microcurrent emitted from the electric shock electrode is 80%; and the third category is 450 Hz to 650 Hz, at which a time of duration of the high-voltage microcurrent emitted from the electric shock electrode is 60%.

8. The manual and automatic dual-purpose bark stopper according to claim 1, wherein a pickup is also connected with a double-trigger switch module in series, and when and only when the pickup detects two consecutive sound signals within 5-10 seconds, is the double-trigger switch module turned on, and the control board issues the bark stopping instruction.

9. The manual and automatic dual-purpose bark stopper according to claim 7, wherein the double-trigger switch module comprises a first and a second NAND gate and a timer, both the first and the second NAND gate are triggered on by the pickup, when the pickup receives a sound signal for a first time, the first NAND gate is turned on and the timer starts to work, when and only when the pickup receives a sound again within 5-10 seconds, is the second NAND gate turned on, and the main control board issues a bark stopping instruction.

10. The manual and automatic dual-purpose bark stopper according to claim 7, wherein the double-trigger switch module comprises a time delay switch and an ordinary switch which are sequentially connected in series, the ordinary switch is triggered on by the pickup through the time delay switch, when the pickup receives a sound signal for the first time, the time delay switch is turned on for 5-10 seconds and then turned off, when the pickup detects a sound again within 5-10 seconds, the ordinary switch is turned on, and the main control board issues a bark stopping instruction.
